(19) United States
(12) Patent Application Publication
(10) Pub. No.: US 2023/0395992 A1
(43) Pub. Date: Dec. 7, 2023

(54) ANTENNA STRUCTURE AND MOBILE TERMINAL

(71) Applicant: JRD COMMUNICATION (SHENZHEN) LTD., Shenzhen, Guangdong (CN)

(72) Inventor: Hongjuan XING, Shenzhen, Guangdong (CN)

(73) Assignee: JRD COMMUNICATION (SHENZHEN) LTD., Shenzhen, Guangdong (CN)

(21) Appl. No.: 18/250,191

(22) PCT Filed: Dec. 9, 2020
(86) PCT No.: PCT/CN2020/134742

§ 371 Date: Apr. 21, 2023

(30) Foreign Application Priority Data
Oct. 23, 2020 (CN) 202011146031.X

(51) Int. Cl. H01Q 21/06; H01Q 1/24

(52) U.S. Cl. CPC H01Q 21/061; H01Q 1/242

(57) ABSTRACT

The present application discloses an antenna structure and a mobile terminal. In the antenna structure of the present application, a radome corresponding to a region between adjacent antenna elements is made of a metal material, and a radome corresponding to a radiation region of the antenna elements is made of a low dielectric constant material, and a fence-type radome structure is formed. Such a design can ensure the performance of an array antenna in the antenna structure, and can improve the product firmness of the antenna structure.

This application claims the priority of the Chinese patent application No. 202011146031.X titled “Antenna structure and Mobile terminal” filed with the China National Intellectual Property Administration on Oct. 23, 2020, which is incorporated by reference in the present application in its entirety.

### BACKGROUND OF DISCLOSURE

### 1. Field of Disclosure

The present disclosure relates to the field of application of mobile devices, in particular to the technical field of antennas, and in particular to an antenna structure and a mobile terminal.

### 2. Description of Related Art

The rapid development of communication technology has brought new opportunities for related industries, but also raised new challenges. Terminal devices, such as mobile phones, with their convenient form and powerful functions have become indispensable electronic products for contemporary people.

As an important device for wireless signal reception and transmission, the performance of an antenna often determines the quality of a mobile phone device. Due to the physical characteristics of the antenna itself, its radiating ability is limited by other metals, high dielectric constant materials and high loss materials around the antenna radiating body.

The current mobile communication technology is the coexistence of 2G, 3G and 4G and is developing in a direction toward 5G technology. In particular, the millimeter wave in 5G technology supports larger bandwidth and higher communication system capacity, which further increases the wireless transmission rate, so millimeter wave communication has become a hotspot function of mobile terminals. Due to the high frequency of millimeter waves and poor diffraction ability, in order to ensure the transmission effect, the radome in front of the array antenna cannot be made of materials with high dielectric constant or conductive materials. For the current mobile terminal products on the market, in order to ensure the performance of the millimeter-wave antenna, the radome in the radiation direction of the antenna can only adopt the following methods: excavate a part of the metal material (that is, a large area) and replace it with plastic or glass of a lower dielectric constant. Such a production process seriously affects the aesthetics of the product, reduces the firmness of the product, and strictly limits the materials used for the appearance of the product.

Hence, how to improve the design of the radome of the millimeter-wave array antenna has become an important topic for relevant technicians and researchers.

Technical Problem:

Embodiments of the present application provide an antenna structure and a mobile terminal. In the antenna structure, the radome corresponding to an area between adjacent antenna elements is made of metal, and the radome corresponding to a radiation area of the antenna element is made of low dielectric constant material and forms a fence-type radome structure. This design can not only ensure the performance of the array antenna in the antenna structure, but also improve the product firmness of the antenna structure.

### SUMMARY

According to an aspect of the present application, an embodiment of the present application provides an antenna structure, which includes: an array antenna, wherein the array antenna is divided into a plurality of antenna elements, the array antenna includes a dielectric substrate, a plurality of radiating metal sheets arranged on one side surface of the dielectric substrate, and a ground plate located on an opposite side of the dielectric substrate, each of the antenna elements corresponds to each of the radiating metal sheets;
a radome, wherein the radome is disposed on one side of the array antenna close to the plurality of radiating metal sheets;
the radome includes a first dielectric constant cover body and a second dielectric constant cover body, the first dielectric constant cover body and the second dielectric constant cover body are spaced apart, and the second dielectric constant cover body is located at a position corresponding to the radiating metal sheets;
wherein a dielectric constant of the first dielectric constant cover body is greater than a preset dielectric constant, and a dielectric constant of the second dielectric constant cover body is smaller than the preset dielectric constant;
a material of the first dielectric constant cover body is a metal material;
a material of the second dielectric constant cover body is a non-conductive material; and
an orthographic projection area of the dielectric substrate on the radome is smaller than an area of the radome.

In at least some embodiments of the present application, the non-conductive material is plastic or glass.

In at least some embodiments of the present application, an operating frequency band of the array antenna is located in the frequency bands of 28 GHz and 39 GHz.

In at least some embodiments of the present application, a plurality of pairs of mutually coupled horizontal feeds and vertical feeds are provided on the opposite side of the dielectric substrate, and each pair of the horizontal feed and the vertical feed is associated with each of the antenna elements.

In at least some embodiments of the present application, perimeter of the radome includes a first dielectric constant cover body.

In at least some embodiments of the present application, the array antenna is a millimeter-wave array antenna.

According to another aspect of the present invention, an embodiment of the present application provides an antenna structure, wherein the antenna structure includes: an array antenna, wherein the array antenna is divided into a plurality of antenna elements, the array antenna includes a dielectric substrate, a plurality of radiating metal sheets arranged on one side surface of the dielectric substrate, and a ground plate located on an opposite side of the dielectric substrate, each of the antenna elements corresponds to each of the radiating metal sheets;
a radome, wherein the radome is disposed on one side of the array antenna close to the plurality of radiating metal sheets;
the radome includes a first dielectric constant cover body and a second dielectric constant cover body, the first dielectric constant cover body and the second dielectric constant cover body are spaced apart, and the second dielectric constant cover body is located at a position corresponding to the radiating metal sheets;
wherein a dielectric constant of the first dielectric constant cover body is greater than a preset dielectric constant, and a dielectric constant of the second dielectric constant cover body is smaller than the preset dielectric constant.

On the basis of the above technical solutions, further improvements can be made.

In at least some embodiments of the present application, a material of the first dielectric constant cover body is a metal material.

In at least some embodiments of the present application, a material of the second dielectric constant cover body is a non-conductive material.

In at least some embodiments of the present application, the non-conductive material is plastic or glass.

In at least some embodiments of the present application, an operating frequency bands of the array antenna is located in the frequency bands of 28 GHz and 39 GHz.

In at least some embodiments of the present application, a plurality of pairs of mutually coupled horizontal feeds and vertical feeds are provided on the opposite side of the dielectric substrate, and each pair of the horizontal feed and the vertical feed is associated with each of the antenna elements.

In at least some embodiments of the present application, an orthographic projection area of the dielectric substrate on the radome is smaller than an area of the radome.

In at least some embodiments of the present application, perimeter of the radome includes a first dielectric constant cover body.

In at least some embodiments of the present application, the array antenna is a millimeter-wave array antenna.

According to another aspect of the present application, a mobile terminal is provided, and the mobile terminal includes the above-mentioned antenna structure.

Useful Effect:

The beneficial effect of the present application is that, compared with the prior art, in the antenna structure of the present application, the radome corresponding to the area between adjacent antenna elements is made of metal, and the radome corresponding to the radiation area of the antenna elements is made of low dielectric constant material and forms a fence-type radome structure. This design can not only ensure the performance of the array antenna in the antenna structure, but also improve the product firmness of the antenna structure.

### BRIEF DESCRIPTION OF DRAWINGS

The technical solutions of the present invention and its beneficial effects will be detailed through the detailed description of the specific embodiments of the present invention below in conjunction with the accompanying drawings.

FIG. 1 shows a positional relationship between a radome and an array antenna in an embodiment of the prior art.

FIG. 2 shows a positional relationship between a radome and an array antenna in another embodiment of the prior art.

FIG. 3 shows a side view of the positional relationship between the radome and the array antenna in the embodiment of the prior art.

FIG. 4 is a schematic diagram showing the antenna structure according to an embodiment of the present application.

FIG. 5 shows another perspective view of the antenna structure in the embodiment of the present application.

FIG. 6 shows a schematic front view of an array antenna in an antenna structure according to the embodiment of the present application.

FIG. 7 shows a schematic diagram of the back of the array antenna in the antenna structure described in the embodiment of the present application.

FIG. 8 shows an exploded schematic diagram of the array antenna in the antenna structure described in the embodiment of the present application.

FIGS. 9A, 9B, 9C, and 9D are schematic diagrams showing the comparison of return loss of the antenna elements of the prior art and the present application.

FIGS. 10A and 10B are actual gain effect diagrams of the prior art and the antenna structure of the present application operating at 28 Ghz.

FIGS. 100 and 10D are 2D effect diagrams of the actual gain shown in FIG. 10A.

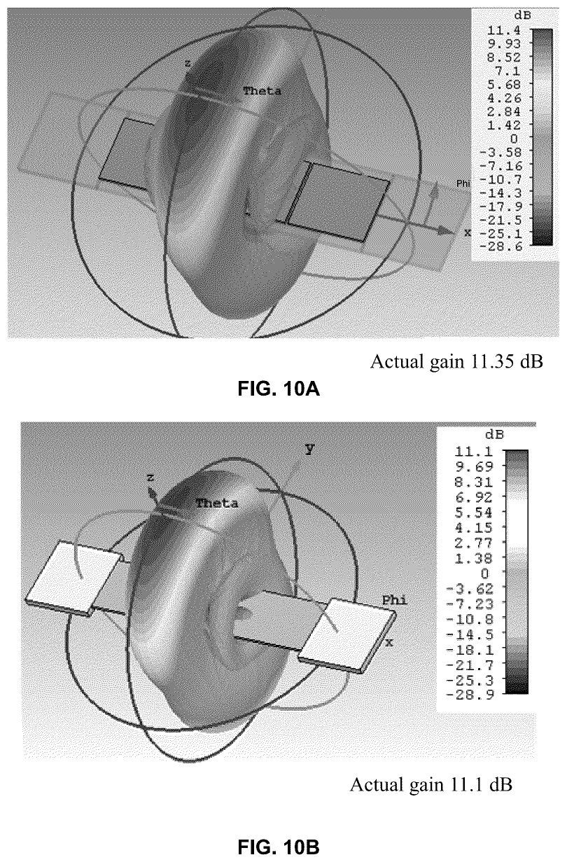

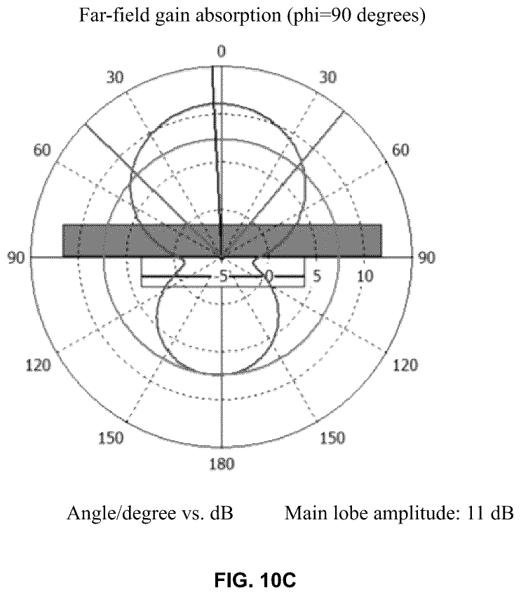

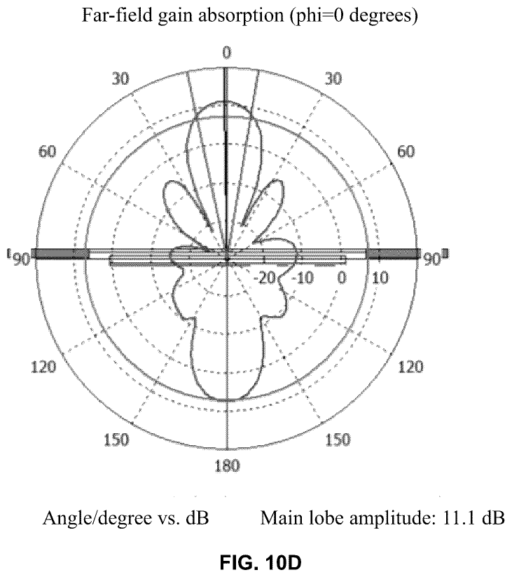

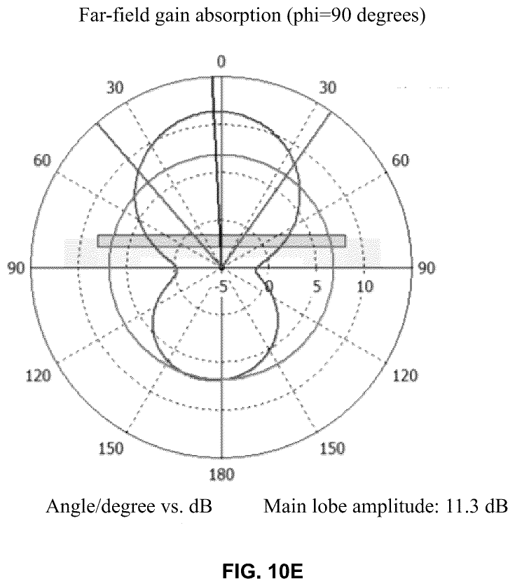

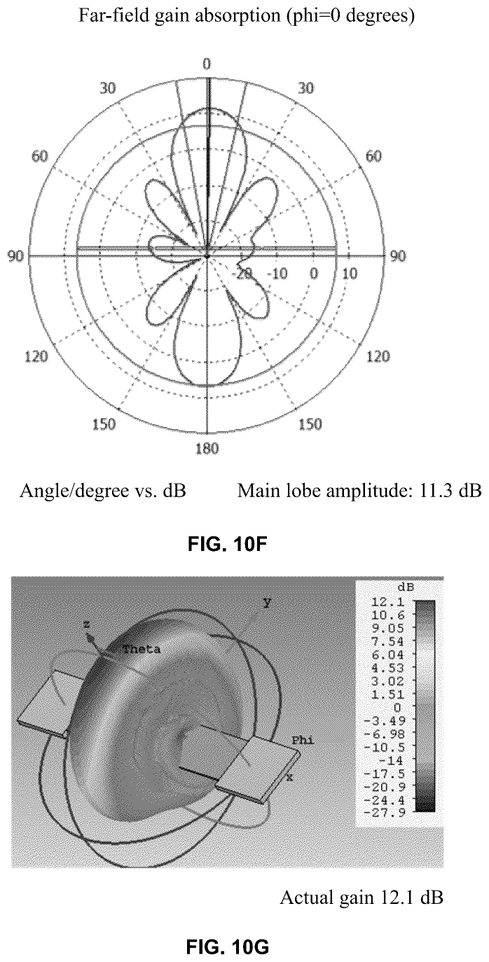

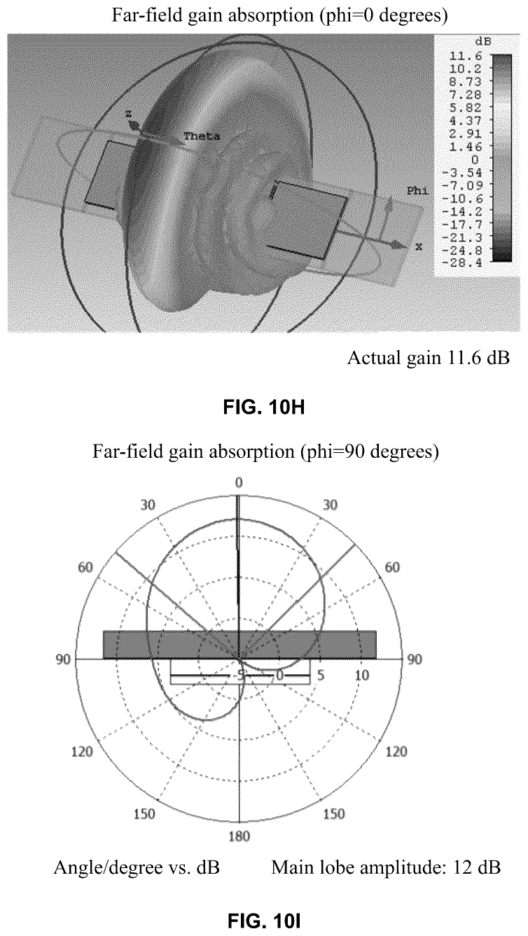

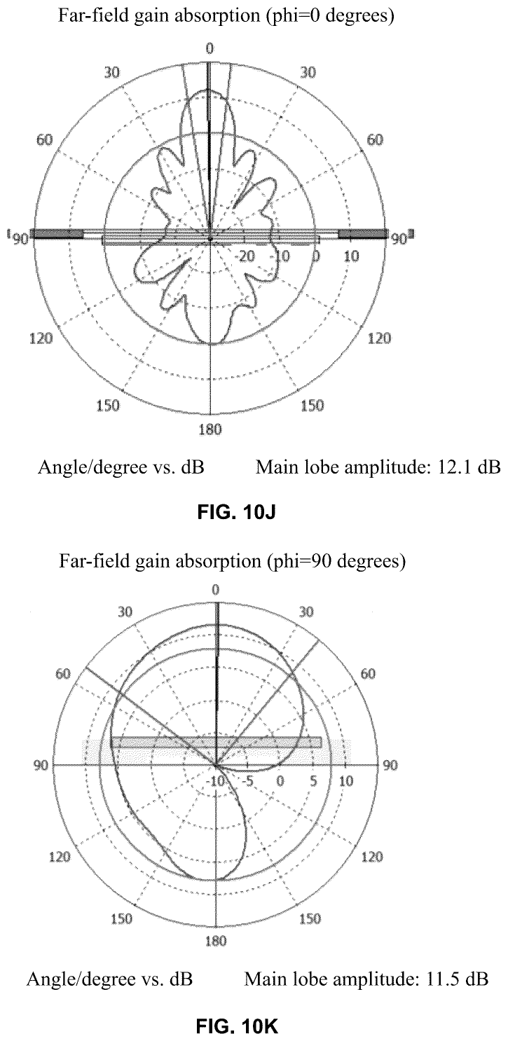

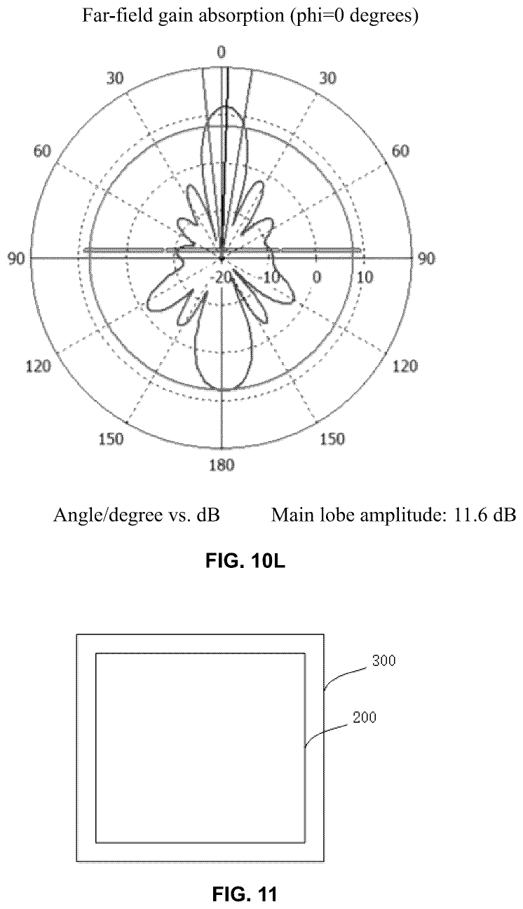

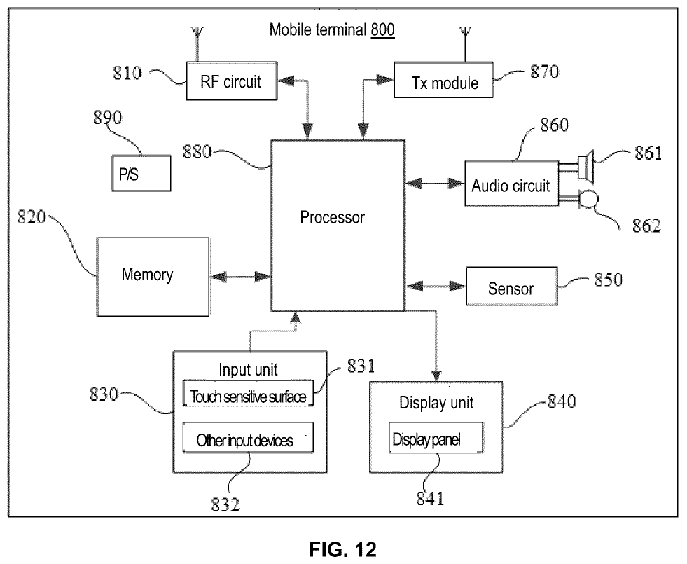

FIGS. 10E and 10F are 2D effect diagrams of the actual gain shown in FIG. 10B.

FIGS. 10G and FIG. 10H are actual gain effect diagrams of the prior art and the antenna structure of the present application operating at 39 Ghz.

FIGS. 10I and 10J are 2D effect diagrams of the actual gain shown in FIG. 10G.

FIGS. 10K and 10L are 2D effect diagrams of the actual gain shown in FIG. 10H.

FIG. 11 shows a schematic diagram of a mobile terminal in an embodiment of the present application.

FIG. 12 shows a specific schematic diagram of a mobile terminal in the embodiment described in this application.

### DETAILED DESCRIPTION OF EMBODIMENTS

The technical solutions in the embodiments of the present application will be clearly and completely described below with reference to the accompanying drawings in the embodiments of the present application. Obviously, the described embodiments are only a part of the embodiments of the present application, but not all of the embodiments. Based on the embodiments in the present application, all other embodiments obtained by those skilled in the art without creative work fall within the protection scope of the present application.

The terms “first”, “second”, “third”, etc. (if present) in the description and claims of the present invention and the above-mentioned drawings are used to distinguish similar objects and are not necessarily used to describe a particular order or sequence. It is to be understood that the objects so described are interchangeable under appropriate circumstances. Furthermore, the terms “comprising” and “having”, and any variations thereof, are intended to cover non-exclusive inclusion.

In the detailed description, the drawings discussed below, and the embodiments used to describe the principles of the present disclosure are by way of illustration only and should not be construed as limiting the scope of the present disclosure. Those skilled in the art will understand that the principles of the invention may be implemented in any suitably arranged system. Exemplary embodiments will be described in detail, examples of which are illustrated in the accompanying drawings. Also, a terminal according to an exemplary embodiment will be described in detail with reference to the accompanying drawings. The same reference numbers in the figures refer to the same elements.

The terms used in this detailed description are used to describe a particular embodiment only and are not intended to illustrate the concepts of the present invention. Expressions in the singular form cover expressions in the plural form unless the context clearly indicates a different meaning. In the present specification, it should be understood that terms such as “including”, “having” and “comprising” are intended to indicate the presence of the possibility of the features, numbers, steps, actions or combinations thereof disclosed in the present specification, and are not intended to exclude the possibility that one or more other features, numbers, steps, actions, or combinations thereof may be present or may be added. The same reference numbers in the drawings refer to the same parts.

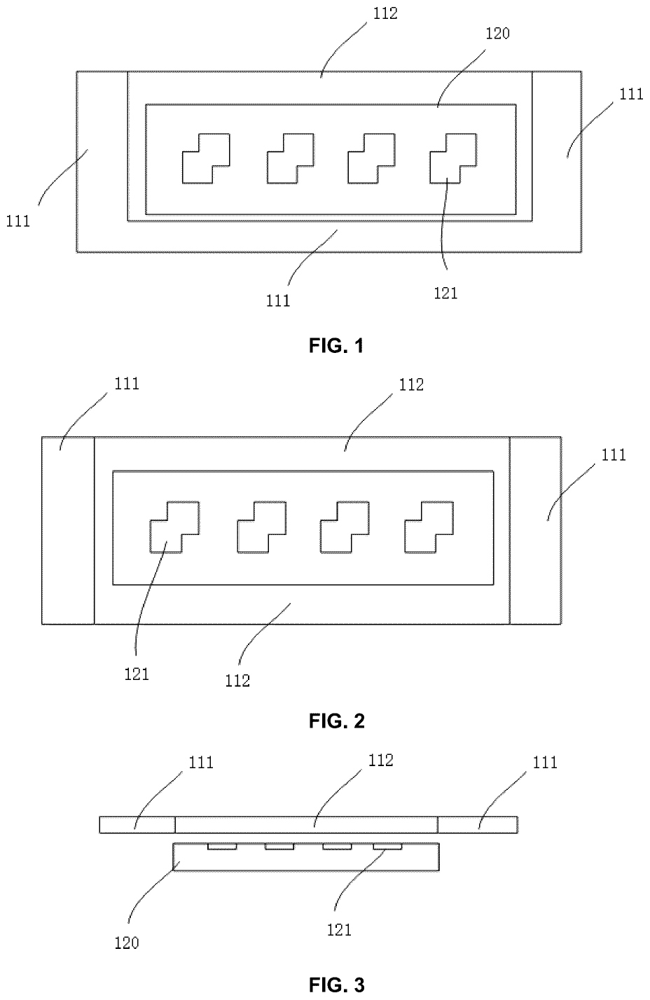

FIG. 1 shows a positional relationship between a radome and an array antenna in an embodiment of the prior art. FIG. 2 shows a positional relationship between a radome and an array antenna in another embodiment of the prior art. FIG. 3 is a side view of the positional relationship between the radome and the array antenna in the embodiment of the prior art.

As shown in FIG. 1 to FIG. 3, among mobile terminal products (e.g., mobile phones) currently on the market, the mobile phone uses a radome of a millimeter-wave antenna. The radome mainly includes the following two design schemes: one scheme is to set the array antenna 120 (which adopts a millimeter wave antenna) on a printed circuit board, and the radiating metal sheet 121 in the array antenna 120 faces the battery cover on the back of the mobile phone, that is, the plane facing the array antenna 120 (i.e., the radome). Since the entire battery cover is made of non-metallic material, the transmission effect of the array antenna 120 using the millimeter-wave antenna can be guaranteed. Another way is to set the array antenna 120 (which adopts a millimeter-wave antenna) on the side of the mobile phone, that is, the metal frame 111 (that is, made of metal material) is used at the left and right positions of the radome, and at least one of upper or lower positions of the radome is made of a non-metallic frame 112 such as plastic or glass (that is, made of non-conductive material), and a middle frame covering the array antenna is a non-metal frame 112 such as plastic or glass that replaces a metal frame. For details, see FIG. 1 to FIG. 3.

Related researchers have found that although the area corresponding to the array antenna is made of non-conductive materials to ensure the transmission effect, hollowing out the area corresponding to the array antenna will not only reduce the structural strength of the mobile phone, but may also affect the appearance of the radome of the mobile phone.

Therefore, the researchers proposed the following scheme.

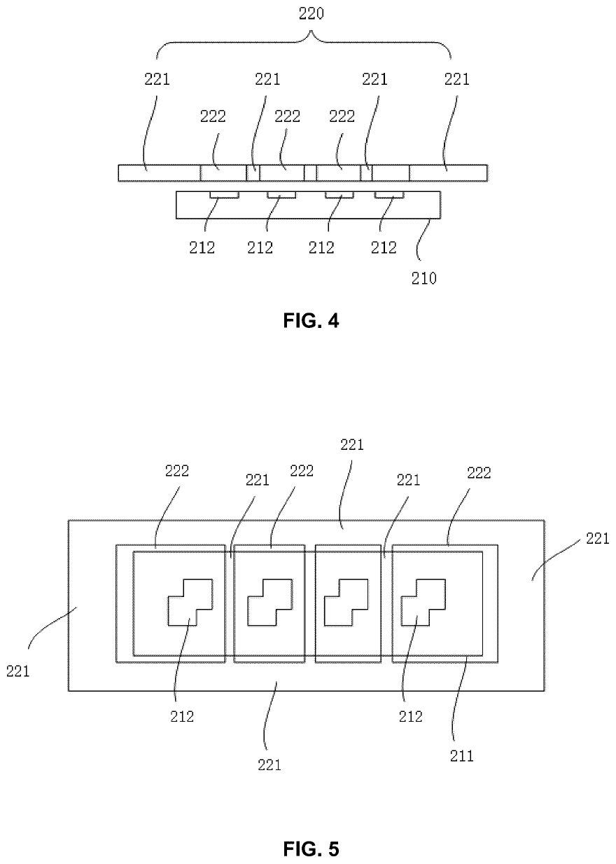

Referring to FIGS. 4 to 8, an embodiment of the present application provides an antenna structure 200, wherein the antenna structure 200 includes: an array antenna 210, wherein the array antenna 210 is divided into a plurality of antenna elements 215, and the array antenna 210 includes a dielectric substrate 211, a plurality of radiating metal sheets 212 disposed on one surface of the dielectric substrate 211, and a ground plate 214 located on the opposite side of the dielectric substrate 211; each of the antenna elements 215 corresponds to each of the radiating metal sheets 212; a radome 220 is disposed on one side of the array antenna 210 close to the plurality of radiating metal sheets 212; the radome 220 includes a first dielectric constant cover body 221 and a second dielectric constant cover body 222, the first dielectric constant cover body 221 and the second dielectric constant cover body 222 are spaced apart, and the second dielectric constant cover body 222 is located at a position corresponding to the radiating metal sheet 212; wherein a dielectric constant of the first dielectric constant cover body 221 is greater than a preset dielectric constant, a dielectric constant of the second dielectric constant cover body 222 is smaller than the preset dielectric constant.

Specifically, the antenna structure 200 includes an array antenna 210 and a radome 220.

The array antenna 210 is divided into a plurality of antenna elements 215. In this embodiment, the number of antenna elements 215 is four. Of course, in other embodiments, the number of antenna elements 215 is not limited to this, and may be three, five, six, and the like.

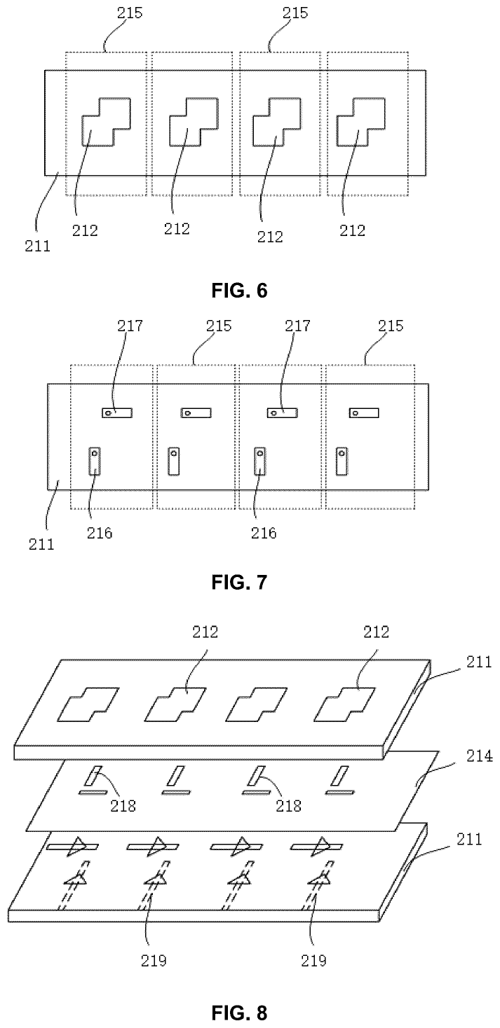

Referring to FIG. 6 to FIG. 8, the array antenna 210 includes a dielectric substrate 211. In this implementation, the dielectric substrate 211 can be a Roger 4350B type dielectric substrate. A plurality of radiating metal sheets 212 are provided on one surface of the dielectric substrate 211. The plurality of radiating metal sheets 212 may be formed on the dielectric substrate 211 by etching. A ground plate 214 is disposed on the opposite side of the dielectric substrate 211. The ground plate 214 may be formed on the other side of the dielectric substrate 211 by etching.

Referring to FIG. 7, further, a plurality of pairs of horizontal feeds 216 and vertical feeds 217 coupled to each other are formed on the opposite side of the dielectric substrate 211. Each pair of the horizontal feed 216 and the vertical feed 217 corresponds to each of the antenna elements 215. That is, each of the antenna elements 215 includes two coupled feeds, one of which is a horizontal feed 216 and the other is a vertical feed 217, which are coupled to each other.

In this embodiment, the four horizontal feeds 216 on the dielectric substrate 211 are used to realize the horizontal polarization when operating frequency bands of the array antenna 210 is at 28 GHz and 39 GHz. The four vertical feeds 217 on the dielectric substrate 211 are used to realize vertical polarization when operating frequency bands of the array antenna 210 is at 28 GHz and 39 GHz.

The array antenna 210 further includes another dielectric substrate 211 on which a plurality of microstrip lines 219 are arranged, and each microstrip line 219 is connected to the corresponding coupled feeds through a corresponding slot 218 arranged on the ground plate 214, so as to transmit the signal to the corresponding radiating metal sheet 212, as shown in FIG. 8.

In this embodiment, the array antenna 210 adopts a millimeter-wave antenna, and the operating frequency bands of the array antenna 210 are located in the frequency bands of 28 GHz and 39 GHz.

In this embodiment, the antenna structure 200 includes a radome 220, and the radome 220 is disposed on one side of the array antenna 210 close to the plurality of radiating metal sheets 212. The radome 220 includes a first dielectric constant cover body 221 and a second dielectric constant cover body 222, the first dielectric constant cover body 221 and the second dielectric constant cover body 222 are spaced apart. The second dielectric constant cover body 222 is located at a position corresponding to the radiating metal sheet 212. Wherein, the material of the first dielectric constant cover body 221 is a metal material (or called a metal material). The material of the second dielectric constant cover body 222 is a non-conductive material (or referred to as a non-conductive material). Specifically, the non-conductive material is plastic or glass. More specifically, the second dielectric constant cover body 222 is located at a position corresponding to a radiation direction of the radiating metal sheet 212.

Since the material of the first dielectric constant cover body 221 is a metal material, the first dielectric constant cover body 221 can generally be referred to as a high dielectric constant cover body. Since the material of the second dielectric constant cover body 222 is a non-conductive material, the second dielectric constant cover body 222 can generally be referred to as a low dielectric constant cover body.

In this embodiment, since the first dielectric constant cover body 221 and the second dielectric constant cover body 222 are spaced apart, that is, the radome is designed in a fence-type radome, and the second dielectric constant cover body 222 is located at the position corresponding to the radiating metal sheet 212 (that is, the position corresponding to the radiation direction), and the array antenna 210 adopts a millimeter-wave antenna. Therefore, this design can ensure the transmission effect of the millimeter-wave antenna and protect radiation of the radiating metal sheet 212 of the array antenna 210 toward the high dielectric constant material from being affected. More importantly, the first dielectric constant cover body 221 and the second dielectric constant cover body 222 are spaced apart, which also avoids a condition where the hollowing out of the metal frame area corresponding to the array antenna in the existing radome (only non-conductive materials are used in the area) reduces structural strength of the entire radome.

In this embodiment, the orthographic projection area of the dielectric substrate 211 on the radome 220 is smaller than the area of the radome 220. Further, periphery of the radome 220 includes the first dielectric constant cover body 221. This design ensures the structural strength of the entire radome 220, and, due to the fence-type radome design, ameliorates impacts on the appearance of the radome 220.

In the antenna structure described in the present application, the radome corresponding to the area between adjacent antenna elements is made of metal material, and the radome corresponding to the radiation area of the antenna element is made of low dielectric constant material, which form the fence-type radome structure. Such a design can not only ensure the performance of the array antenna in the antenna structure, but also improve the product firmness of the antenna structure.

In addition, the fence-type radome of the present application has the metal material of the radiating metal sheet 212 in the radiation direction being replaced with a plastic material or glass material with a low dielectric constant, instead of the metal middle frame corresponding to the entire array antenna in the prior art, therefore, can ensure the continuity of the metal material to the greatest extent.

In addition, the fence-type radome of the present application hardly causes attenuation to the performance of the array antenna. The fence-type radome of the present application and the radome design described above (as shown in FIGS. 1 to 3) are basically consistent with the performance of the array antenna, and the specific comparison data are as follows.

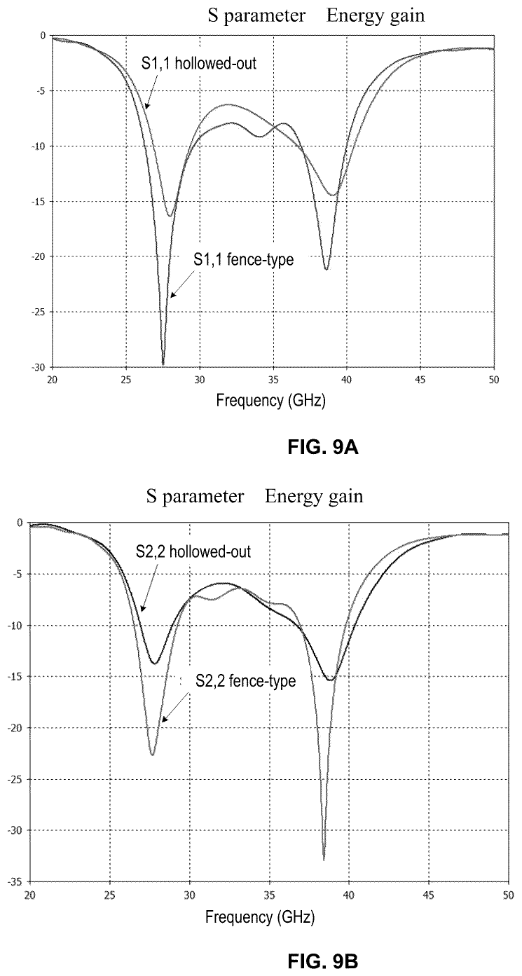

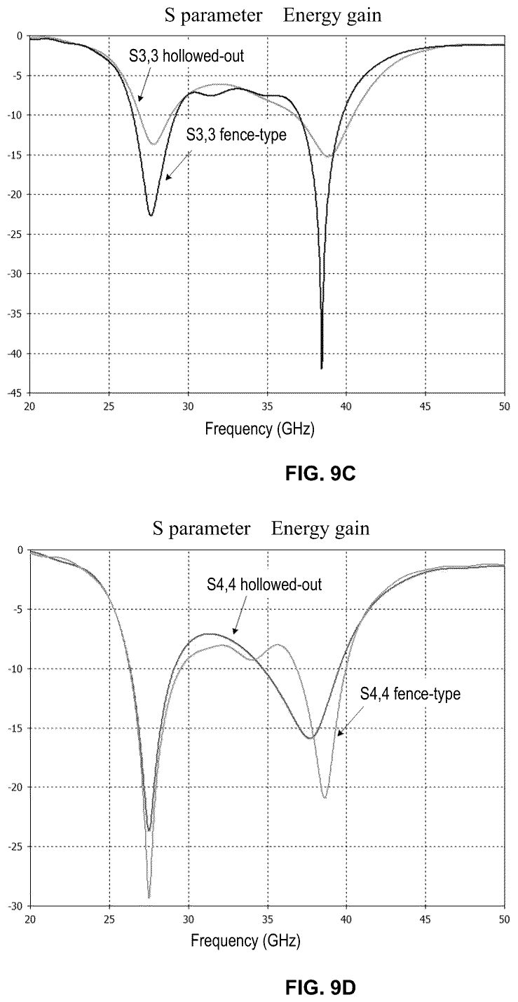

FIGS. 9A, 9B, 9C, and 9D are schematic diagrams showing the comparison of return loss of the antenna element of the prior art and the present application.

FIG. 9A shows the situations of the first antenna element when the hollowed-out radome (the prior art) and the fence radome (the present application) are respectively used, the abscissa represents the frequency, and the ordinate represents the return loss energy of the antenna element. FIG. 9B shows the situations of the second antenna element when the hollowed-out radome (the prior art) and the fence-type radome (the present application) are respectively used, the abscissa represents the frequency, and the ordinate represents the return loss energy of the antenna element. FIG. 9C shows the situations of the third antenna element when the hollowed-out radome (the prior art) and the fence type radome (the present application) are respectively used, the abscissa represents the frequency, and the ordinate represents the return loss energy of the antenna element size. FIG. 9D shows the situations of the fourth antenna element when the hollowed-out radome (the prior art) and the fence type radome (the present application) are respectively used, the abscissa represents the frequency, and the ordinate represents the return loss energy of the antenna element.

FIGS. 10A and 10B are the actual gain effect diagrams of the prior art and the antenna structure of the present application operating at 28 Ghz, and FIGS. 100 and 10D are the 2D effect diagrams of the actual gain shown in FIG. 10A. FIGS. 10E and 10F are a 2D diagram of the actual gain shown in FIG. 10B. In particular, Theta in FIGS. 10A and 10B represents angle, and Phi represents angle. FIGS. 100 and 10E are the case where the far-field gain absorption (phi=90 degrees) is achieved. FIGS. 10D and 10F are the far-field gain absorption (phi=0 degrees).

When the array antenna operates at 28 GHz and the existing radome is used, the actual gain is 11.35 dB, the main lobe amplitude is 11 dB (the far field achieves gain absorption (phi=90 degrees)), and the main lobe amplitude is 11.1 dB (the far field achieves gain absorption (phi=0 degrees)). When the array antenna works at 28 GHz and uses the fence-type radome, the actual gain is 11.1 dB, the main lobe amplitude is 11.3 dB (the far field achieves gain absorption (phi=90 degrees)), and the main lobe amplitude is 11.3 dB (the far field achieves gain absorption (phi=0 degrees)). It can be seen that the difference between the actual gain and the main lobe amplitude of the existing radome and the fence radome of the present application is controlled to be less than 0.5 dB, respectively.

FIG. 10G and FIG. 10H are the actual gain effect diagrams of the prior art and the antenna structure of the present application working at 39 Ghz, and FIG. 101 and FIG. 10J are the 2D effect diagrams of the actual gain shown in FIG. 10G. FIG. 10K and FIG. 10L are a 2D diagram of the actual gain shown in FIG. In particular, Theta in FIGS. 10G and 10H represents the angle, and Phi represents the angle. FIG. 101 and FIG. 10K are the cases where the far-field gain absorption (phi=90 degrees) is achieved, and FIGS. and 10L are the cases where the far-field gain absorption (phi=0 degrees) is achieved.

When the array antenna works at 39 GHz and the existing radome is used, the actual gain is 12.1 dB, the main lobe amplitude is 12 dB (the far field achieves gain absorption (phi=90 degrees)), and the main lobe amplitude is 12.1 dB (the far field achieves gain absorption (phi=0 degrees)). When the array antenna operates at 39 GHz and uses a fence radome, the actual gain is 11.6 dB, and the main lobe amplitude is 11.5 dB (far field achieves gain absorption (phi=90 degrees)), and the main lobe amplitude is 11.6 dB (far field achieves gain absorption (phi=0 degrees)). It can be seen that the difference between the actual gain and the main lobe amplitude of the existing radome and the fence radome of the present application is controlled to be less than 0.5 dB, respectively.

Therefore, it can be seen that the fence-type radome of the present application and the above-mentioned radome design has substantially the same performance on the array antenna.

FIG. 11 is a schematic diagram of a mobile terminal in an embodiment of the present application.

The present application provides a mobile terminal 300, where the mobile terminal 300 includes the above-mentioned antenna structure 200. The details of the antenna structure 200 are as described above and are not repeated here. Wherein, the mobile terminal 300 may be a mobile phone, a tablet computer, a personal assistant computer, etc., but is not limited thereto.

FIG. 12 is a specific schematic diagram of a mobile terminal in the embodiment described in this application.

Referring to FIG. 12, an embodiment of the present invention further provides a mobile terminal, and the mobile terminal 800 may be a mobile phone or a tablet. The mobile terminal also includes the following components.

A radio frequency (RF) circuit 810 is used for receiving and sending electromagnetic waves, realizing mutual conversion between electromagnetic waves and electrical signals, so as to communicate with a communication network or other devices. RF circuit 810 may include various existing circuit elements for performing these functions, e.g., radio frequency transceivers, digital signal processors, encryption/decryption chips, subscriber identity module (SIM) cards, memory, and the like. The RF circuit 810 may communicate with various networks such as the Internet, an intranet, a wireless network, or with other devices over a wireless network. The aforementioned wireless network may include a cellular telephone network, a wireless local area network, or a metropolitan area network. The above-mentioned wireless networks can use various communication standards, protocols and technologies, including but not limited to the Global System for Mobile Communications (GSM), Enhanced Mobile Communication Technology (Enhanced Data GSM Environment, EDGE), Wideband Code Division Multiple Access (WCDMA), code division multiple access (CDMA) technology, Time Division Multiple Access (TDMA), Wireless Fidelity (Wi-Fi) (e.g. Institute of Electrical and Electronics Engineers standards IEEE 802.11a, IEEE 802.11b, IEEE802.11g and/or IEEE 802.11n), Internet telephony (Voice over Internet Protocol, VoIP), Worldwide Interconnection for Microwave Access (Wi-Max), other protocols for mail, instant messaging, and short messaging, and any other suitable communication protocols, even those that are not currently being developed.

A memory 820 can be used to store software programs and modules. A processor 880 executes various functional applications and data processing by running the software programs and modules stored in the memory 820. Memory 820 may include high-speed random-access memory, and may also include non-volatile memory, such as one or more magnetic storage devices, flash memory, or other non-volatile solid-state memory. In some instances, the memory 820 may further include memory located remotely from the processor 880, and these remote memories may be connected to the mobile terminal 800 through a network. Examples of such networks include, but are not limited to, the Internet, an intranet, a local area network, a mobile communication network, and combinations thereof.

An input unit 830 may be used to receive input numerical or character information, and generate keyboard, mouse, joystick, optical or trackball signal input related to user settings and function control. Specifically, the input unit 830 may include a touch-sensitive surface 831 as well as other input devices 832. Touch-sensitive surface 831, also known as a touch display or trackpad, collects user touch operations on or near it (such as a user using a finger, stylus, etc., any suitable object or accessory on or near touch-sensitive surface 831), and drive the corresponding connection device according to a preset program. Optionally, the touch-sensitive surface 831 may include two parts, a touch detection device and a touch controller. Among them, the touch detection device detects the user's touch orientation, detects the signal brought by the touch operation, and transmits the signal to the touch controller. The touch controller receives the touch information from the touch detection device, converts it into contact coordinates, and then sends it to the processor 880, and can receive and execute the command sent by the processor 880. Additionally, the touch-sensitive surface 831 may be implemented using resistive, capacitive, infrared, and surface acoustic wave types. In addition to the touch-sensitive surface 831, the input unit 830 may also include other input devices 832. Specifically, other input devices 832 may include, but are not limited to, one or more of physical keyboards, function keys (such as volume control keys, switch keys, etc.), trackballs, mice, joysticks, and the like.

A display unit 840 may be used to display information input by or provided to the user and various graphical user interfaces of the mobile terminal 800, which may be composed of graphics, text, icons, videos, and any combination thereof. The display unit 840 may include a display panel 841 using, optionally, a liquid crystal display (LCD), organic light emitting diode (OLED) and the like. Further, the touch-sensitive surface 831 may cover the display panel 841. When detecting a touch operation on or near it, the touch-sensitive surface 831 transmits the detected touch to the processor 880 that further determines the type of the touch event. Subsequently, the processor 880 provides corresponding visual output on display panel 841 according to the touch event. Although in FIG. 12, the touch-sensitive surface 831 and the display panel 841 are implemented as two separate components to realize the input and output functions, in some embodiments, the touch-sensitive surface 831 and the display panel 841 may be integrated to realize the input and output functions.

The mobile terminal 800 may also include at least one sensor 850, such as a light sensor, a motion sensor, and other sensors. Specifically, the light sensor may include an ambient light sensor and a proximity sensor, wherein the ambient light sensor may adjust the brightness of the display panel 841 according to the brightness of the ambient light, and the proximity sensor may close the display panel 841 when the mobile terminal 800 is moved to the ear and/or backlight. As a kind of motion sensor, a gravitational acceleration sensor can detect the magnitude of acceleration in all directions (usually three axes) and the magnitude and direction of gravity when it is stationary, and can be used to recognize gestures (e.g., for switching landscape-portrait display orientations, games, magnetometer attitude calibration), vibration recognition related functions (such as pedometer, tapping), etc. As for other sensors such as gyroscope, barometer, hygrometer, thermometer, infrared sensor, etc. that can also be configured into the mobile terminal 800, will not be redundantly detailed here.

An audio circuit 860, the speaker 861, and the microphone 862 may provide an audio interface between the user and the mobile terminal 800. The audio circuit 860 can transmit to the speaker 861 electrical signals converted from received audio data, and the speaker 861 converts them into sound signals for output. On the other hand, the microphone 862 converts the collected sound signals into electrical signals, and the audio circuit 860 converts the electrical signals into audio data, and outputs the audio data to the processor 880 for processing, and then sends to, for example, another terminal through the RF circuit 810, or outputs the audio data to the memory 820 for further processing. The audio circuit 860 may also include an earphone jack to provide communication between peripheral headphones and the mobile terminal 800.

The mobile terminal 800 can help the user to send and receive emails, browse web pages, access streaming media, etc. through a transmission module 870 (e.g., a Wi-Fi module) that provides the user with wireless broadband Internet access. Although FIG. 12 shows the transmission module 870, it can be understood that it does not an essential component of the mobile terminal 800 and can be completely omitted as required without changing the essence of the invention.

The processor 880 is a control center of the mobile terminal 800, and uses various interfaces and lines to connect various parts of the entire mobile phone, by running or executing the software programs and/or modules stored in the memory 820, and calling the data stored in the memory 820, performs various functions of the mobile terminal 800 and process data, so as to monitor the whole mobile phone. Optionally, the processor 880 may include one or more processing cores. In some embodiments, the processor 880 may integrate an application processor and a modem processor, wherein the application processor mainly handles the operating system, user interface and applications, etc. A modem processor mainly deals with wireless communication. It can be understood that the above-mentioned modem processor may not be integrated into the processor 880.

The mobile terminal 800 also includes a power source 890 (P/S) (such as a battery) for powering various components. In some embodiments, the power source can be logically connected to the processor 880 through a power management system, so as to manage charging, discharging, power consumption management, and other functions through the power management system. Power source 890 may also include one or more DC or AC power sources, recharging systems, power failure detection circuits, power converters or inverters, power status indicators, and any other components.

Although not shown, the mobile terminal 800 may further include a camera (e.g., a front camera, a rear camera), a Bluetooth module, and the like, which will not be redundantly described herein. Specifically in this embodiment, the display unit of the mobile terminal is a touch screen display, the mobile terminal further includes a memory, and one or more programs, wherein one or more programs are stored in the memory and configured to be executed by one or more aforementioned processors.

During specific implementation, the above modules can be implemented as independent entities, or can be arbitrarily combined to be implemented as the same or several entities. The specific implementation of the above modules can refer to the previous method embodiments, which will not be repeated here.

An antenna structure and a mobile terminal are provided in the embodiments of the present application. In the antenna structure described in the present application, the radome corresponding to the area between adjacent antenna elements is made of metal material, and the radome corresponding to the radiation area of the antenna element is made of low dielectric constant material and forms a fence type radome structure. Such a design can not only ensure the performance of the array antenna in the antenna structure, but also improve the product firmness of the antenna structure.

The antenna structure and the mobile terminal provided by the embodiments of the present invention are described above in detail. The principles and implementations of the present invention are described in this paper by using specific examples. The descriptions of the above embodiments are only used to help understand the present invention. At the same time, for those skilled in the art, according to the idea of the present invention, there will be changes in the specific implementation and application scope. To sum up, the content of this specification should not be construed as invention limitations.

### INDUSTRIAL APPLICABILITY

The subject matter of the present application can be manufactured and used in industry with industrial applicability.

What is claimed is:

1. An antenna structure comprising:
an array antenna, wherein the array antenna is divided into a plurality of antenna elements, the array antenna includes a dielectric substrate, a plurality of radiating metal sheets arranged on one side surface of the dielectric substrate, and a ground plate located on an opposite side of the dielectric substrate, each of the antenna elements corresponds to each of the radiating metal sheets;
a radome, wherein the radome is disposed on one side of the array antenna close to the plurality of radiating metal sheets;
the radome includes a first dielectric constant cover body and a second dielectric constant cover body, the first dielectric constant cover body and the second dielectric constant cover body are spaced apart, and the second dielectric constant cover body is located at a position corresponding to the radiating metal sheets;
wherein a dielectric constant of the first dielectric constant cover body is greater than a preset dielectric constant, and a dielectric constant of the second dielectric constant cover body is smaller than the preset dielectric constant;
a material of the first dielectric constant cover body is a metal material;
a material of the second dielectric constant cover body is a non-conductive material; and
an orthographic projection area of the dielectric substrate on the radome is smaller than an area of the radome.

2. The antenna structure according to claim 1, wherein the non-conductive material is plastic or glass.

3. The antenna structure according to claim 1, wherein an operating frequency band of the array antenna is located in the frequency bands of 28 GHz and 39 GHz.

4. The antenna structure according to claim 1, wherein a plurality of pairs of mutually coupled horizontal feeds and vertical feeds are provided on the opposite side of the dielectric substrate, and each pair of the horizontal feed and the vertical feed is associated with each of the antenna elements.

5. The antenna structure according to claim 1, wherein perimeter of the radome includes a first dielectric constant cover body.

6. The antenna structure according to claim 1, wherein the array antenna is a millimeter-wave array antenna.

7. An antenna structure comprising:
an array antenna, wherein the array antenna is divided into a plurality of antenna elements, the array antenna includes a dielectric substrate, a plurality of radiating metal sheets arranged on one side surface of the dielectric substrate, and a ground plate located on an opposite side of the dielectric substrate, each of the antenna elements corresponds to each of the radiating metal sheets;
a radome, wherein the radome is disposed on one side of the array antenna close to the plurality of radiating metal sheets;
the radome includes a first dielectric constant cover body and a second dielectric constant cover body, the first dielectric constant cover body and the second dielectric constant cover body are spaced apart, and the second dielectric constant cover body is located at a position corresponding to the radiating metal sheets;
wherein a dielectric constant of the first dielectric constant cover body is greater than a preset dielectric constant, and a dielectric constant of the second dielectric constant cover body is smaller than the preset dielectric constant.

8. The antenna structure according to claim 7, wherein a material of the first dielectric constant cover body is a metal material.

9. The antenna structure according to claim 7, wherein a material of the second dielectric constant cover body is a non-conductive material. The antenna structure according to claim 9, wherein the non-conductive material is plastic or glass.

11. The antenna structure according to claim 7, wherein an operating frequency band of the array antenna is located in the frequency bands of 28 GHz and 39 GHz.

12. The antenna structure according to claim 7, wherein a plurality of pairs of mutually coupled horizontal feeds and vertical feeds are provided on the opposite side of the dielectric substrate, and each pair of the horizontal feed and the vertical feed is associated with each of the antenna elements.

13. The antenna structure according to claim 7, wherein an orthographic projection area of the dielectric substrate on the radome is smaller than an area of the radome.

14. The antenna structure according to claim 7, wherein perimeter of the radome includes a first dielectric constant cover body.

15. The antenna structure according to claim 7, wherein the array antenna is a millimeter-wave array antenna.

16. A mobile terminal, wherein the mobile terminal includes the antenna structure of claim 7.
